(19) United States
(12) Patent Application Publication
(10) Pub. No.: US 2010/0005946 A1
(43) Pub. Date: Jan. 14, 2010

(54) DRUM SHELL

(75) Inventors: Toshitaka Yoshino, Hamamatsu-shi (JP); Yukimasa Okumura, Hamamastu (JP); Hiroyasu Abe, Hamamatsu-shi (JP); Takuya Abe, Kakegawa-shi (JP); Hironao Nagashima, Hamamatsu-shi (JP)

Correspondence Address: DICKSTEIN SHAPIRO LLP, 1633 Broadway, NEW YORK, NY, 10019, US

(73) Assignee: YAMAHA CORPORATION, Hamamatsu-Shi, Shizuoka-ken (JP)

(21) Appl. No.: 12/487,043

(22) Filed: Jun. 18, 2009

(30) Foreign Application Priority Data
Jul. 9, 2008 (JP) 2008-179175

(51) Int. Cl. G10D 13/02; B32B 21/04; B29C 59/02

(52) U.S. Cl. 84/411 R; 428/35.6; 264/320

(57) ABSTRACT

A drum shell is constituted of at least one laminate wood in which at least one fiber-reinforced layer (e.g. a carbon fabric) is inserted between two wooden materials via the adhesive and which is rolled up in a cylindrical shape. By setting the mass per unit area of the fiber-reinforced layer ranging from 5 g/m² to 75 g/m², it is possible to prevent the detachment of fibers inside the fiber-reinforced layer while controlling the shearing loss with respect to the laminate wood. The drum shell is equipped with at least one drumhead so as to produce a drum with a high sound quality and with a fine-grained exterior appearance.

### BACKGROUND OF THE INVENTION

1. Field of the Invention

The present invention relates to drum shells for use in drums. The present invention also relates to manufacturing methods for drum shells.

The present application claims priority on Japanese Patent Application No. 2008-179175, the content of which is incorporated herein by reference.

2. Description of the Related Art

Various types of membranophones such as drums, tambourines, congas, bongos, and Japanese drums have been produced and are popular among people. Drums are designed to produce sounds when beaten by human hands or external instruments, which cause vibrations or resonations of membranes (e.g. drumheads).

Drums are each designed such that a membrane (or a skin) is stretched over one opening or both openings of a shell having a cylindrical shape or a frame-shape. Shells are made of wooden materials, metals, or the like. Wooden shells are each manufactured by bending a laminate-wood (or plywood) into a cylindrical shape.

Various technologies regarding drum shells have been developed and disclosed in various documents such as Patent Documents 1 to 3.

Patent Document 1: Japanese Unexamined Patent Application Publication No. 2003-316349
Patent Document 2: Japanese Unexamined Patent Application Publication No. S60-98490
Patent Document 3: Japanese Unexamined Patent Application Publication No. H06-43857

Patent Document 1 teaches a drum shell laminate structure which is constituted of a first sheet material layer (composed of polyester), a second sheet material layer (composed of hard phenol), and an adhesive material or a bonding web for bonding the first and second sheet materials layers together, wherein an elastic modulus of the first sheet material layer is imparted to the second sheet material layer.

The drum shell laminate structure requires a complex structure and a complex manufacturing process since the first sheet material layer differs from the second sheet material layer in property. In addition, the adhesive material or bonding web has a relatively high shearing loss, which in turn degrades sound quality.

Patent Document 2 teaches a musical soundboard in which a plurality of carbon-fiber reinforced sheets each having a condensation resin matrix are intervened between a plurality of wooden veneers, which are thus integrally combined together.

The above musical soundboard is normally used in a planar form and is produced by combining two wooden veneers (whose thickness ranges from 2 mm to 4 mm) and one wooden veneer (whose thickness ranges from 1 mm to 4 mm) together so that the overall thickness thereof may be 5 mm or more. The musical soundboard whose thickness is 5 mm or more is hardly bent into a cylindrical shell. In addition, this musical soundboard is not designed to produce a desired sound quality suited to percussion instruments.

Patent Document 3 teaches a resonating body of a percussion instrument, in which a fiber-reinforced synthetic resin layer and a wood-chip layer (in which wood chips are connected using the resin of the fiber-reinforced synthetic resin layer) are alternately laminated in a thickness direction.

In the manufacturing of the resonating body of a percussion instrument in which the fiber-reinforced synthetic resin layer and the wood-chip layer are alternately laminated along the interior surface of a mold, unevenness or irregularities may be easily formed on the surface of the resonating body, which thus lacks an exterior smoothness, since a resin is applied to the wood-chip layer after wood chips have been dispersed on the fiber-reinforced synthetic resin layer. Compared to a resonating body in which wooden veneers are simply combined together, the above resonating body is degraded in the exterior appearance since the wood-chip layer thereof does not have grains. In addition, sheared fibers of wood chips give rise to a sound-damping factor and also increase the amount of resin used for the formation of the resonating body; hence, Patent Document 3 cannot exploit the inherent property of woods.

### SUMMARY OF THE INVENTION

It is an object of the present invention to provide a drum shell whose sound quality is improved by controlling a shearing loss and which presents a beautiful exterior appearance.

It is another object of the present invention to provide a manufacturing method for manufacturing the above drum shell for use in a drum.

In one embodiment of the present invention, a drum shell is constituted of at least one laminate wood in which at least one fiber-reinforced layer is inserted between a first wooden material and a second wooden material via the adhesive. Preferably, a carbon fabric is used as the fiber-reinforced layer. In addition, the mass per unit area of the fiber-reinforced layer may range from 5 g/m² to 75 g/m².

Alternatively, a drum shell is formed by sequentially laminating a plurality of laminate woods together via the interlaminate adhesive.

A drum is produced by attaching at least one drumhead to an opening of at least one laminate wood which is rolled up into a cylindrical shape.

In another embodiment of the present invention, a drum shell is produced by rolling up at least one laminate wood; inserting the laminate wood into a hollow space of an external mold; inserting an internal mold along the interior surface of the laminate wood, thus tightly sandwiching the laminate wood between the internal mold and the external mold and forming it into a cylindrical shape; then, heating the laminate wood together with the external mold.

The present invention demonstrates the following effects.
(1) Due to the insertion of the fiber-reinforced layer between the first and second wooden materials via the adhesive, it is possible to increase the specific elastic modulus and to reduce the shearing loss with respect to the laminate wood, thus noticeably improving the sound quality.
(2) Since the fine-grained exterior surface of the laminate wood is used to form the exterior surface of the drum shell, it is possible to improve the exterior appearance of the drum shell.
(3) When the carbon fabric is used as the fiber-reinforced layer, it is possible to increase the strength of the laminate wood, thus increasing the durability to bending stress.
(4) By setting the mass per unit area of the fiber-reinforced layer ranging from 5 g/m² to 75 g/m², it is possible to prevent the detachment of fibers inside the fiber-reinforced layer while reducing the shearing loss.
(5) It is possible to produce a drum including the above drum shell with a low shearing loss and a high sound quality.

### BRIEF DESCRIPTION OF THE DRAWINGS

These and other objects, aspects, and embodiments of the present invention will be described in more detail with reference to the following drawings.

FIG. 1 is a perspective view showing the exterior appearance of a drum including a drum shell according to a preferred embodiment of the present invention.

FIG. 2 is a perspective view partly in cross section showing a single unit of a laminate wood including a single fiber-reinforced layer for use in the drum shell.

FIG. 3 a cross-sectional view showing a drum shell which is formed using a single laminate-wood.

FIG. 4 is a cross-sectional view showing a drum shell which is formed using a plurality of laminate-woods.

FIG. 5 is a perspective view partly in cross section showing a single unit of a laminate wood including two fiber-reinforced layers.

FIG. 6A is a perspective view showing that three laminate woods are rolled up and combined together.

FIG. 6B is a perspective view showing an external mold having the laminate woods collectively inserted therein.

FIG. 7A is a perspective view of an internal mold.

FIG. 7B is a perspective view showing that the external mold having the laminate woods is arranged to receive the internal mold therein.

FIG. 8 is a cross-sectional view showing that a heater is attached to the external mold that sandwiches the laminate woods with the internal mold.

FIG. 9 is a cross-sectional view showing a drum shell including three laminate woods.

FIG. 10 is a fragmentary cross-sectional view showing a part of a drum shell including two laminate woods and one non-fabric laminate wood.

FIG. 11 is a fragmentary cross-sectional view showing a part of a drum shell including one laminate wood and two non-fabric laminate woods.

FIG. 12 is a fragmentary cross-sectional view showing a part of a drum shell including two laminate woods and one non-fabric laminate wood.

FIG. 13 is a graph showing measurement results regarding variations of damping factors in connection with sound-propagating velocities with respect to various types of drum shells.

### DESCRIPTION OF THE PREFERRED EMBODIMENTS

The present invention will be described in further detail by way of examples with reference to the accompanying drawings.

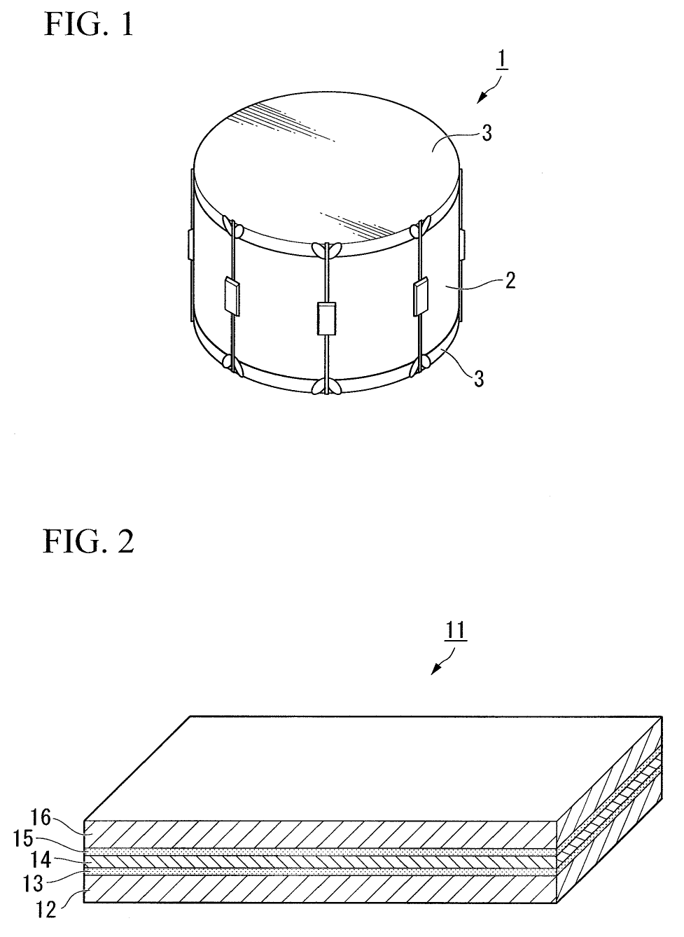

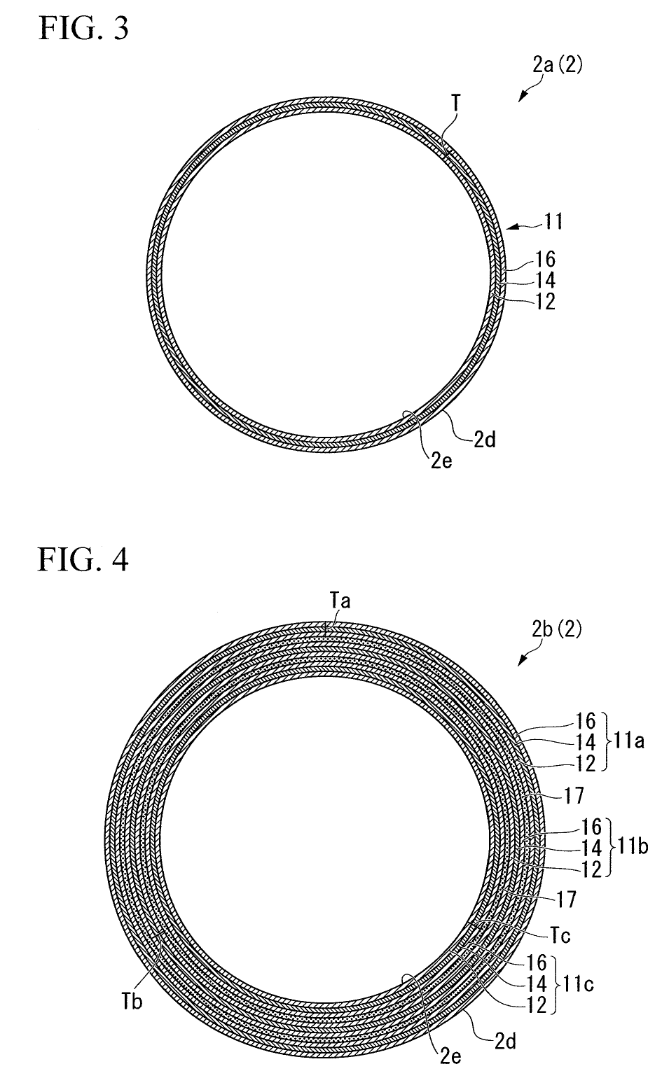

FIG. 1 is a perspective view showing the exterior appearance of a drum 1 according to a preferred embodiment of the present invention. FIG. 2 is a perspective view partly in cross section showing a single unit of a laminate-wood (or plywood) 11 used for the formation of a drum shell 2 for use in the drum 1. FIG. 3 is a cross-sectional view showing a drum shell 2a (pertaining to the drum shell 2) for use in drum 1. FIG. 4 is a cross-sectional view showing a drum shell 2b (pertaining to the drum shell 2) for use in the drum 1.

The drum 1 of FIG. 1 is constituted of the drum shell 2 and drumheads (or head-membranes) 3. The drum shell 2 is produced by forming a single laminate-wood 11 in a hollow cylindrical shape. Alternatively, the drum shell 2 is produced by laminating a plurality of laminate-woods 11, which is then formed in a hollow cylindrical shape. The drumheads 3 are attached to and stretched over both the opposite openings of the cylindrically-shaped drum shell 2. When the drumhead 3 is beaten with a human hand or a drumstick, the drumhead 3 vibrates (or resonates) so as to produce a sound.

The material of the drumhead 3 is not necessarily limited to a specific one, wherein it is possible to use barks, skins, and the like. The overall structure of the drum 1 is not necessarily limited to that shown in FIG. 1; hence, the present invention is applicable to various types of drums such as tambourines, congas, bongos, and Japanese drums.

FIG. 2 shows the constitution of a single unit of the laminate-wood 11 for use in the drum shell 2. In the laminate-wood 11 of FIG. 2, a fiber-reinforced layer 14 is sandwiched between a first wooden material (or a first veneer) 12 and a second wooden material (or a second veneer) 16 via a first adhesive layer 13 and a second adhesive layer 15. In other words, the laminate-wood 11 is formed by sequentially laminating the first wooden material 12, the first adhesive layer 13, the fiber-reinforced layer 14, the second adhesive layer 15, and the second wooden material 16 in order. The drum shell 2 is formed using one laminate-wood 11 or using two or more laminate-woods 11. When the drum shell 2 is formed by laminating two or more laminate-woods 11, it is preferable that the laminate-woods 11 be combined together and then bonded together using the interlaminate adhesive (which will be described later).

As the first and second wooden materials 12 and 16 for use in the laminate-wood 11, it is preferable to use birch, spruce, maple, Japanese oak, meranti, tamo, poplar, bubinga, mahogany, zelkova, kapur, beech, etc. Both the first and second wooden materials 12 and 16 can be formed using the same wooden material. Alternatively, they can be formed using different wooden materials. The thickness of the first and second wooden materials 12 and 16 may range from 0.5 mm to 1.5 mm. It is difficult to perform bending on the first and second wooden materials 12 and 16 of a large thickness, which in turn unreasonably increases shearing loss. In addition, the first and second wooden materials 12 and 16 of a small thickness lead to the necessity of using a number of laminate-woods 11 for the formation of the drum shell 2 having an adequate strength. This requires a complex manufacturing process; and this increases the probability of causing bonding failure between the adjacent laminate-woods 11.

The first and second wooden materials 12 and 16 are positioned opposite to each other via the fiber-reinforced layer 14 in such a way that the fiber-aligning directions thereof are perpendicular to each other or in parallel with each other. It is possible to control the sound quality of the drum 1 by appropriately adjusting the fiber-aligning directions of the first and second wooden materials 12 and 16. Even when the fiber-aligning directions of the first and second wooden materials 12 and 16 are arranged in parallel with each other, it is possible to prevent the laminate-wood 11 from being accidentally broken or partially split during the bending into a cylindrical shape due to the insertion of the fiber-reinforced layer 14 therebetween. That is, the drum shell 2 of the present embodiment demonstrates a high sound quality which cannot be produced by the conventional drum shells formed by laminating veneers.

It is possible to use an epoxy adhesive for the first and second adhesive layers 13 and 15, for example. Specifically, it is preferable to use a two-pack epoxy resin adhesive “AW136·HY994” produced by Nagase ChemteX Corp. It is preferable to set the applied amount of the first and second adhesive layers 13 and 15 to around 180 g/m². In other words, the applied amount preferably ranges from 90 g/m² to 270 g/m². When the applied amount is less than 90 g/m², an accidental breakdown occurs in the fiber-reinforced layer 14 during the bending of the laminate-wood 11 into a cylindrical shape. The applied amount exceeding 270 g/m² slows down an increasing effect for a specific elastic modulus E/ρ of the laminate-wood 11 due to the first and second adhesive layers 13 and 15, thus significantly degrading the sound quality.

It is preferable to use a fabric for the fiber-reinforced layer 14, for example. It may be a best choice to use a carbon fabric for the fiber-reinforced layer 14. Since fibers of a carbon fabric aggregate into the fiber-reinforced layer 14, the fiber-aligning direction thereof is oriented in one direction, or it is subjected to isotropic orientation. Preferably, fibers are woven in an isotropic direction. It is preferable to set the lengths of fibers to about 12 mm and to set the thickness to about 0.01 mm, for example.

The mass per unit area for the fiber-reinforced layer 14 preferably ranges from 5 g/m² to 75 g/m². A large mass per unit area for the fiber-reinforced layer 14 needs to increase the applied amount of the first and second adhesive layers 13 and 15 in order to prevent the detachment of fibers in the fiber-reinforced layer 14, which in turn increases the shearing loss. In order to prevent increasing the applied amount of the first and second adhesive layers 13 and 15, the mass per unit area for the fiber-reinforced layer 14 needs to be reduced to 75 g/m² or less. A small mass per unit area for the fiber-reinforced layer 14 reduces an effect of increasing the specific elastic modulus E/ρ of the laminate-wood 11 (where E denotes Young's modulus, and ρ denotes density), which in turn makes it difficult to control the shearing loss by use of bonding materials.

As the interlaminate adhesive used for laminating the laminate-woods 11 together, it is possible to use the urea adhesive, vinyl acetate adhesive, and vinyl urethane adhesive, for example. As the urea adhesive, it is possible to use “UL-3300S.W” produced by Gunei Chemical Industry Co. Ltd. As the vinyl acetate adhesive, it is possible to use “Core Lock” produced by Nippon NSC Ltd. The applied amount of the interlaminate adhesive is preferably set to around 120 g/m². Insufficient applied amount of the interlaminate adhesive may easily causes the detachment of the laminate woods 11. An excessively applied amount increases the shearing loss due to the interlaminate adhesive, which in turn degrades the sound quality. For this reason, the applied amount of the interlaminate adhesive should range from 80 g/m² to 160 g/m². The above applied amount is the amount of the interlaminate adhesive per each laminate wood 11; hence, the total applied amount for a pair of the laminate woods 11 is double the above values. That is, the total applied amount should range from 160 g/m² to 320 g/m², wherein it is preferably set to 240 g/m².

As shown in FIG. 2, the laminate wood 11 is produced in such a way that the fiber-reinforced layer 14 is inserted between the first and second wooden materials 12 and 16 via the first and second adhesive layers 13 and 15. This structure increases the specific elastic modulus E/ρ of the laminate wood 11; hence, it is possible to control the shearing loss by use of the adhesive and to reduce the damping factor of sound.

FIG. 3 is a cross-sectional view of the drum shell 2a which is formed by bending a single laminate wood 11 into a hollow cylindrical shape, wherein for the sake of convenience, FIG. 3 excludes the illustration of the first and second adhesive layers 13 and 15. A single laminate wood 11 is bent into a cylindrical shape in such a way that the opposite ends thereof are bonded together while matching with each other. Reference symbol T designates a matching point between the opposite ends of the laminate wood 11. Since the drum shell 2a has a single matching point T, it is preferable that one or more wooden veneers be laminated along the interior surface while being shifted in position at the matching point T, thus securing an adequate strength.

FIG. 4 is a cross-sectional view of the drum shell 2b which is formed by laminating three laminate woods 11a, 11b, and 11c in a hollow cylindrical shape. Similar to FIG. 3, FIG. 4 excludes the illustration of the first and second adhesive layers 13 and 15. Interlaminate adhesives 17 are applied between the laminate woods 11a to 11c. In FIG. 4, reference symbols Ta, Tb, and Tc designate matching points with respect to the laminate woods 11a, 11b, and 11c, respectively. As shown in FIG. 4, the laminate woods 11a to 11c are laminated together while shifting the matching points Ta to Tc in position, thus improving the overall strength of the drum shell 2b.

In the drum shells 2a and 2b shown in FIGS. 3 and 4, the first wooden material 12 is exposed on an interior surface 2e, while the second wooden material 16 is exposed on an exterior surface 2d. Thus, it is possible to form a fine wooden appearance on the exterior of the drum shell 2.

The present invention is not necessarily designed to use the laminate wood 11 including a single fiber-reinforced layer 14. That is, it is possible to use another laminate wood including double fiber-reinforced layers.

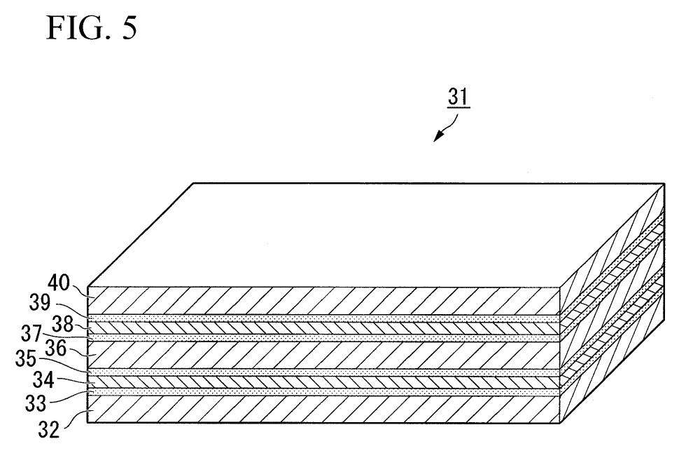

FIG. 5 shows a single unit of a laminate wood 31 including two fiber-reinforced layers, wherein two fiber-reinforced layers 34 and 38 are inserted between a first wooden material 32 and a second wooden material 40 and is laminated together with a third wooden material 36 via four adhesive layers 33, 35, 37, and 39. Specifically, the laminate wood 31 is formed by sequentially laminating the first wooden material 32, the first adhesive layer 33, the first fiber-reinforced layer 34, the second adhesive layer 35, the third wooden material 36, the third adhesive layer 37, the second fiber-reinforced layer 38, the fourth adhesive layer 39, and the second wooden material 40 in order.

The wooden materials 32, 36, and 40 included in the laminate wood 31 of FIG. 5 are formed in the same structure as the wooden materials 12 and 16 included in the laminate wood 11 of FIG. 2. The wooden materials 32, 36, and 40 are positioned opposite to each other via the fiber-reinforced layers 34 and 38 in such a way that the fiber-aligning directions thereof are perpendicular to each other or in parallel with each other.

The material and the applied amount of the adhesive layers 33, 35, 37, and 39 are determined similar to those of the adhesive layers 13 and 15.

In addition, the mass per unit area, the material, and the fiber-aligning direction of the fiber-reinforced layers 34 and 38 are determined similar to those of the fiber-reinforcing layer 14.

A single unit of the laminate wood 31 is bent into a hollow cylindrical shape, thus producing the drum shell 2. Alternatively, a plurality of laminate woods 31 is laminated together and is bent into a hollow cylindrical shape, thus producing the drum shell 2. In the latter one, a plurality of laminate woods 31 is bonded together using the interlaminate adhesive, similar to the drum shell 2b including a plurality of laminate woods 11a to 11c.

In the laminate wood 31 shown in FIG. 5, the two fiber-reinforced layers 34 and 38 are inserted between the first and second wooden materials 32 and 40 via the adhesive layers 33, 35, 37, and 39. This structure increases the specific elastic modulus E/ρ of the laminate wood 31, wherein it is possible to control the shearing loss by the adhesive layers and to reduce the sound damping factor.

Next, a manufacturing method of the laminate wood 11 shown in FIG. 2 will be described below.

First, the first and second wooden materials 12 and 16 are prepared in advance. Subsequently, the first adhesive layer 13 is applied to one surface of the first wooden material 12, while the second adhesive layer 15 is applied to one surface of the second wooden material 16. For example, the epoxy adhesive (used as the adhesive layers 13 and 15) is applied to the wooden material by the applied amount of about 180 g/m².

Next, the fiber-reinforced layer 14 is attached onto one of the first and second adhesive layers 13 and 15. As the fiber-reinforced layer 14, it is possible to use a carbon fabric with the mass per single area ranging from 5 g/m² to 75 g/m², for example.

Thereafter, the first and second wooden materials 12 and 16 are combined together in such a way that the first and second adhesive layers 13 and 15 attached thereto are positioned opposite to each other. Subsequently, the first and second adhesive layers 13 and 15 are subjected to thermal hardening at a temperature of 80° C. for 15 minutes while being placed under the pressure of 1.0 MPa, for example. Thus, it is possible to completely produce the laminate wood 11 shown in FIG. 2.

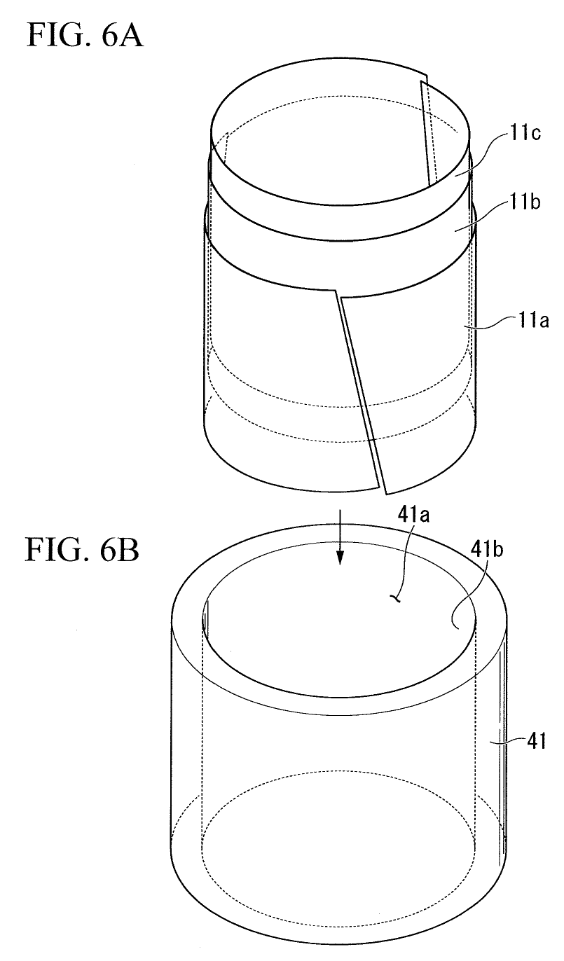

Next, a manufacturing method of the drum shell 2b shown in FIG. 4 will be described with reference to FIGS. 6A, 6B, 7A, 7B, and 8. This manufacturing method stipulates that at least one laminate wood is inserted into the hollow space of an external mold having a cylindrical shape and is temporarily cast into a cylindrical shape, then, an internal mold is inserted into the laminate wood, thus forming a drum shell composed of the laminate wood held between the internal mold and the external mold.

Three laminate woods 11 (i.e. 11a, 11b, and 11c), which are prepared in advance, are collectively rolled up to overlap each other as shown in FIG. 6A and are then inserted into a hollow space 41a of an external mold 41 as shown in FIG. 6B. FIGS. 6A and 6B show that the three laminate woods 11a to 11c are combined together in a cylindrical shape, whereas at least one laminate wood 11 can be combined with other laminate woods.

The external mold 41 is a hollow cylinder having the hollow space 41a surrounded by an interior surface 41b serving as an externally molding surface.

The outmost laminate wood 11a is rolled up and is then inserted into the hollow space 41a of the external mold 41. It is preferable that the laminate wood 11a be formed in a parallelogram shape, thus slantingly arranging the matching point Ta in the height direction as shown in FIG. 6A.

The interlaminate adhesive is applied to the interior surface of the laminate wood 11a. In addition, the interlaminate adhesive is applied to the exterior surface of the laminate wood 11b which is combined with the laminate wood 11a in the next procedure. As the interlaminate adhesive, it is possible to use the urea adhesive, vinyl acetate adhesive, vinyl urethane adhesive, and the like. The applied amount of the interlaminate adhesive is set to 120 g/m², for example.

The laminate wood 11b is rolled up and is then inserted into the hollow space 41a along the interior surface of the laminate wood 11a. Similar to the laminate wood 11a, it is preferable that the laminate wood 11b be formed in a parallelogram shape.

Subsequently, the interlaminate adhesive is applied to the interior surface of the laminate wood 11b and the exterior surface of the laminate wood 11c (which is combined with the laminate wood 11b in the next procedure). The laminate wood 11c is rolled up and is then inserted into the hollow space 41a along the interior surface of the laminate wood 11b. Thus, it is possible to temporarily combine the laminate woods 11a to 11c together.

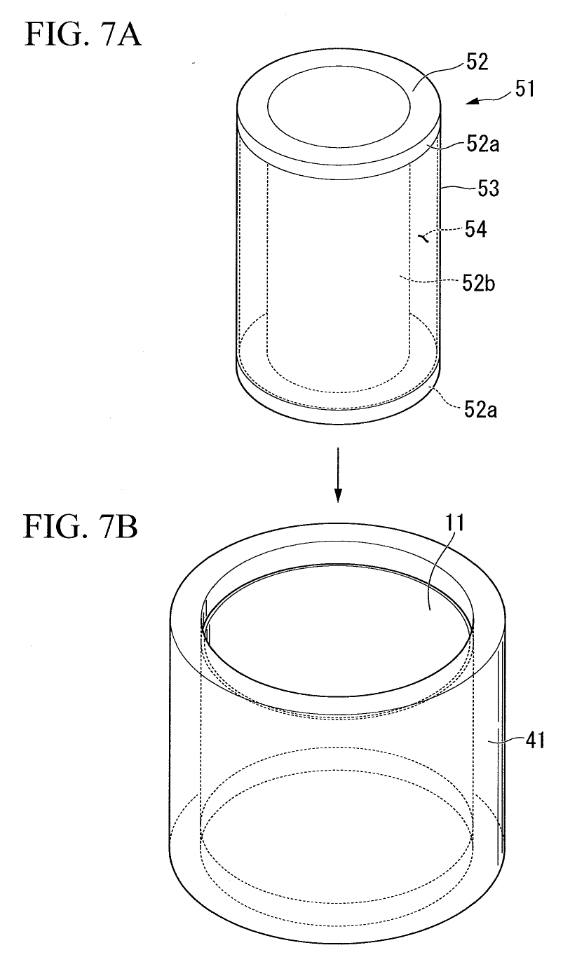

FIG. 7A shows an internal mold 51 including an insertion member 52 and a balloon 53 composed of an elastic membrane such as rubber. The insertion member 52 is constituted of two disk-shaped flanges 52a and a cylinder 52b (which is sandwiched between the flanges 52a with a diameter smaller than that of the flanges 52a). The balloon 53 is positioned in the outer periphery of the cylinder 52b. An air chamber 54 is formed by the flanges 52a, the cylinder 52b, and the balloon 53. The air chamber 54 is connected to an air supply device via a pipe (not shown). The air supply device supplies the compressed air into the air chamber 54 so as to expand the elastic membrane of the balloon 53. In the internal mold 51, the exterior surface of the elastic membrane of the balloon 53 serves as an internal molding surface.

As shown in FIG. 7B, the internal mold 51 is inserted into the hollow space 41a of the external mold 41 so that the laminate woods 11a to 11c are collectively sandwiched between the external mold 41 and the internal mold 51.

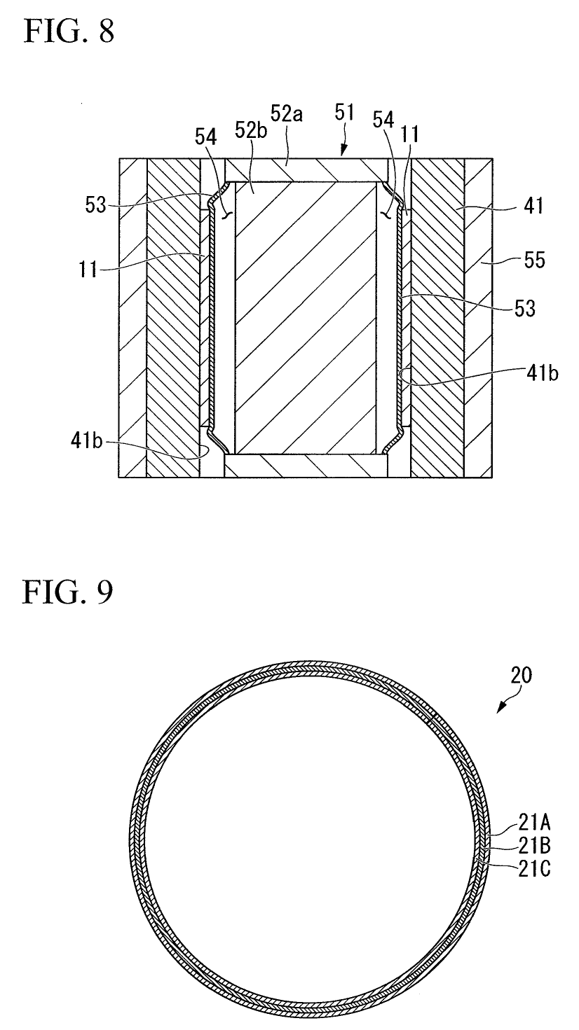

As shown in FIG. 8, a heater 55 is attached to the outer periphery of the external mold 41 and is activated to heat the laminate woods 11a to 11c together with the external mold 41, while the compressed air is supplied into the air chamber 54 of the internal mold 51 so as to expand the balloon 53. The balloon 53 exerts a pressing force to the laminate woods 11a to 11c, which are thus uniformly pressed to the interior surface 41b of the external mold 41. Due to the heat generated by the heater 55, the laminate woods 11a to 11c are partially deformed while the interlaminate adhesive is hardened. The pressure of the compressed air supplied to the balloon 53 is set to about 0.5 MPa, for example. The heating temperature is set to about 100° C., and the heating time is set to about one hour, for example. Thus, it is possible to unify the laminate woods 11a to 11c mutually adhered together.

Lastly, the unified laminate woods 11a to 11c are extracted from the external mold 41 and the internal mold 51; then, unwanted edges on the upper and lower ends thereof are cut out. Thereafter, coating is applied to the exterior surface and the interior surface of the unified laminate woods 11a to 11c) as necessary. Thus, it is possible to finish the drum shell 2b.

The drumheads 3 are attached to the opposite openings of the drum shell 2b so as to produce the drum 1.

According to the drum shell 2 of the present embodiment in which the fiber-reinforced layer 14 composed of a carbon fabric is inserted between the first and second adhesive layers 13 and 15 for bonding the first and second wooden materials 12 and 16 together, it is possible to increase the specific elastic modulus E/ρ, and it is possible to control the shearing loss by the adhesive, thus improving the sound quality.

Since the fiber-reinforced layer 14 is composed of a “closely woven” fabric, it is possible to increase the specific elastic modulus E/ρ with respect to the drum shell 2. This increases the strength of the laminate wood 11 so as to increases the durability with respect to a bending stress.

Since the mass per unit area of the fiber-reinforced layer 14 ranges from 5 g/m² to 75 g/m², it is possible for the adhesive of the first and second adhesive layers 13 and 15 to penetrate into the fiber-reinforced layer 14; hence, it is possible to prevent the detachment of fibers inside the fiber-reinforced layer 14.

According to the drum shell 2 of the present embodiment, it is possible to control the specific elastic modulus E/ρ and the shearing loss without changing the wooden quality between the laminate woods 12 and 16 which are oppositely positioned via the fiber-reinforced layer 14.

The present embodiment produces the drum shell 2 using the laminate wood 11 in which the fiber-reinforced layer 14 is sandwiched between the first and second wooden materials 12 and 16, wherein it is possible to improve the moldability while reducing the thickness of the drum shell 2. That is, the present embodiment is applicable to various sizes of drum shells.

The present embodiment presents the beautiful appearance because the laminate wood is used as the exterior surface of the drum shell 2 with a fine-grained appearance and smoothness.

The drum 1 including the drum shell 2 is reduced in shearing loss and is thus improved in sound quality.

The manufacturing method of the drum shell 2 of the present embodiment is simplified in processing because it does not require the conventional process for having the resin penetrate into the reinforced fabric in advance.

The present invention is not necessarily limited to the present embodiment, which can be modified in a variety of ways as follows:

FIG. 9 is a cross-sectional view showing a drum shell 20 in which at least one laminate wood including a reinforced fabric is laminated together with another laminate wood not including a reinforced fabric (hereinafter, referred to as a non-fabric laminate wood).

The drum shell 20 of FIG. 9 is constituted of three laminate woods 21A, 21B, and 21C.

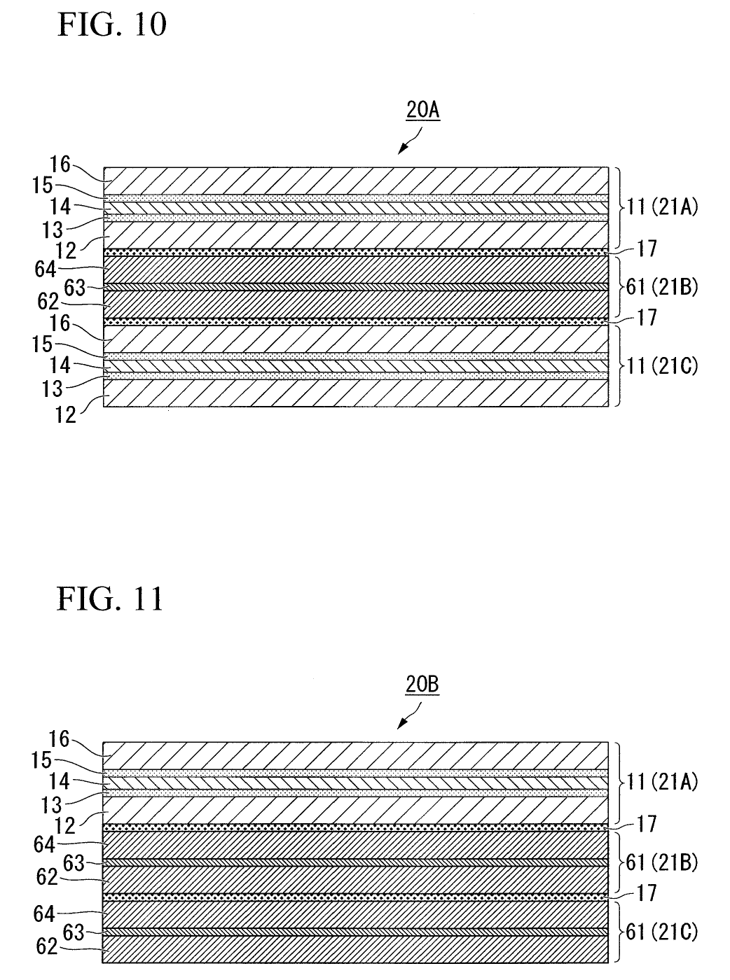

FIG. 10 is a fragmentary cross-sectional view showing a part of a drum shell 20A (pertaining to the drum shell 20) in which a non-fabric laminate wood 61 (i.e. 21B) is sandwiched between two laminate woods 11 (i.e. 21A and 21C) including reinforced fabrics.

The laminate woods 11 are each formed in the same structure of FIG. 2 including the first wooden material 12, the first adhesive layer 13, the fiber-reinforced layer 14, the second adhesive layer 15, and the second wooden material 16, which are sequentially laminated together.

The non-fabric laminate wood 61 includes a first wooden material 62, an adhesive layer 63, and a second wooden material 64, which are sequentially laminated together.

Similar to the wooden materials 12 and 16, the wooden materials 62 and 64 are each composed of birch, spruce, and the like, and the thickness thereof ranges from 0.5 mm to 1.5 mm.

As the adhesive layer 63, it is possible to use the aforementioned interlaminate adhesive, such as the urea adhesive, a vinyl acetate adhesive, or a vinyl urethane adhesive. It is preferable that the applied amount of the adhesive layer 63 be set to around 120 g/m². Insufficient applied amount of the adhesive layer 63 may easily cause detachment between the wooden materials 62 and 64. Excessive applied amount may increase the shearing loss due to the adhesive layer 63. Therefore, it is preferable that the applied amount range from 80 g/m² to 160 g/m². This applied amount is set to each of the wooden materials 62 and 64; hence, the total applied amount is double the above value, wherein it is preferable that the total applied amount range from 160 g/m² to 320 g/m², so that the total applied amount is preferably set to 240 g/m².

Similar to the drum shell 2b shown in FIG. 4, the drum shell 20A is formed by bonding the laminate woods 11 (i.e. 21A and 21C) with the non-fabric laminate wood 61 (i.e. 21B) via the interlaminate adhesive 17. The type and applied amount of the interlaminate adhesive 17 shown in FIG. 10 is determined in a manner similar to those of the interlaminate adhesive 17 shown in FIG. 4.

FIG. 11 is a fragmentary cross-sectional view showing a part of a drum shell 20B (pertaining to the drum shell 20) including one laminate wood 11 (i.e. 21A) and two non-fabric laminate woods 61 (i.e. 21B and 21C), which are sequentially laminated together.

The laminate wood 11 and the non-fabric laminate wood 61 are already discussed above in conjunction with FIG. 10. The drum shell 20B is similar to the drum shell 2b such that the laminate wood 11 and the non-fabric laminate woods 61 are bonded together via the interlaminate adhesive 17.

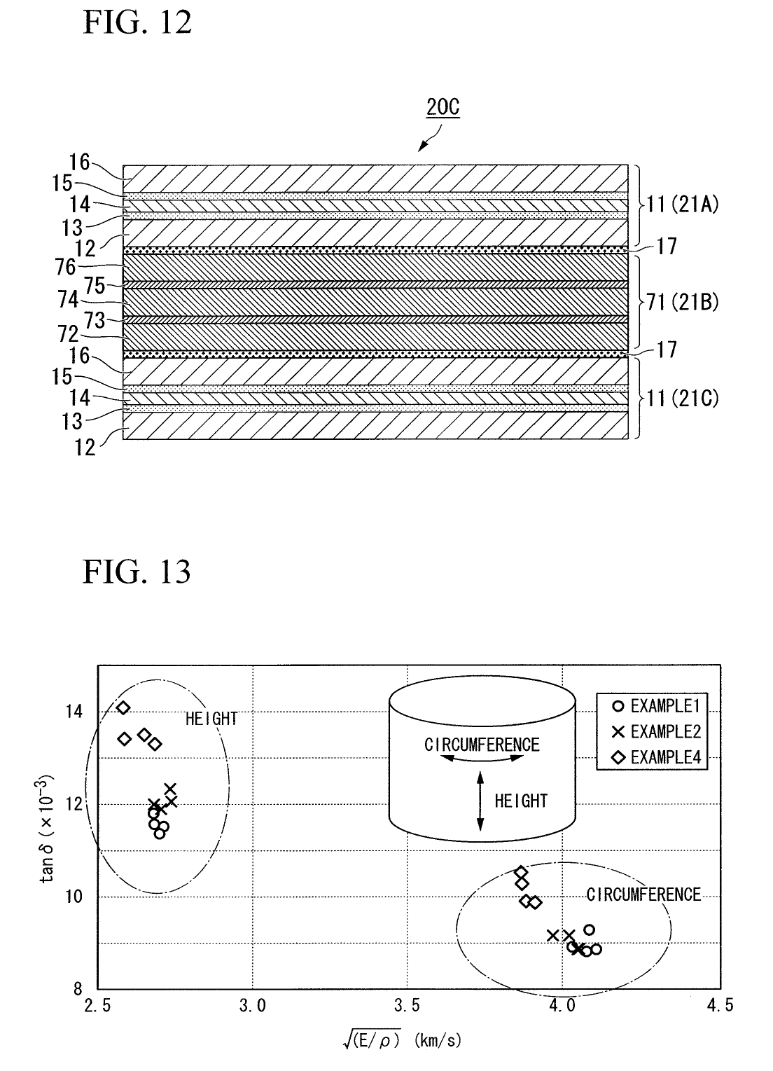

FIG. 12 is a fragmentary cross-sectional view showing a drum shell 20C (pertaining to the drum shell 20) in which a non-fabric laminate wood 71 (i.e. 21B) is sandwiched between two laminate woods 11 (i.e. 21A and 21C).

The laminate woods 11 of the drum shell 20C are formed similar to those of the drum shells 20A and 20B. The drum shell 20C is similar to the drum shell 2b shown in FIG. 4 such that the laminate woods 11 are bonded together with the non-fabric laminate wood 71 via the interlaminate adhesive 17.

The non-fabric laminate wood 71 includes a first wooden material 72, a first adhesive layer 73, a second wooden material 74, and a second adhesive layer 75, and a third wooden material 76, which are sequentially laminated together. Similar to the wooden materials 12 and 16, the wooden materials 72, 74, and 76 are each composed of birch, spruce, and the like, wherein the thickness thereof ranges from 0.5 mm to 1.5 mm.

The material and applied amount of the adhesive layers 73 and 75 are similar to those of the adhesive layer 63 shown in FIGS. 10 and 11.

The drum shells 20A to 20C shown in FIGS. 10 to 12 demonstrate the same effects as the drum shell 2.

To verify the property of the present embodiment, four types of laminate woods are produced as Examples 1 to 4).

### (1) EXAMPLE 1

First and second wooden materials composed of a birch are each formed in the prescribed dimensions, i.e. a length of 430 mm, a width of 2160 mm, and a thickness of 1 mm. The wooden materials are laminated together in such a way that the fiber-aligning direction of the first wooden material is laid in a longitudinal direction, while the fiber-aligning direction of the second wooden material is laid in a lateral direction.

The epoxy adhesive (e.g. two-pack epoxy resin adhesive “AW136·HY994” produced by Nagase ChemteX Corp.) is applied to each of the surfaces of the two wooden materials with the applied amount of 90 g/m².

A carbon fabric is attached onto the adhesive layer of the first wooden material. The “Trayca-Mat” BO030 produced by Toray Industries, Inc. with the mass per unit area of 30 g/m2, an average fiber diameter of 0.01 mm, an average fiber length of 12 mm, and an isotropic fiber orientation is employed as the carbon fabric.

The first and second wooden materials are unified together such that the adhesive-layered surfaces thereof match each other; then, they are heated at a temperature of 80° C. for 15 minutes under a pressure of 1.0 MPa, thus hardening the epoxy adhesive. Thus, it is possible to finish the laminate wood of Example 1.

### (2) EXAMPLES 2, 3, and 4

Examples 2 and 3 are each produced similar to Example 1 except that Example 2 uses the carbon fabric (i.e. the “Trayca-Mat” BO030 produced by Toray Industries, Inc.) with the mass per unit area of 60 g/m², while Example 3 uses the carbon fabric with the mass per unit area of 90 g/m².

Example 4 is produced similar to Example 1 except for using the carbon fabric.

Thus, it is possible to finish the laminates woods of Examples 2, 3, and 4.

### (3) DRUM SHELLS

Four types of drum shells are produced using the laminate woods of Examples 1 to 4 respectively. Three laminate woods (corresponding to one of Examples 1 to 4) are rolled up into a cylindrical shape in which the interlaminate adhesive is applied between the adjacent laminate woods. The urea adhesive (i.e. “UL-3300S.W produced by Gunei Chemical Industry Co. Ltd.) is used as the interlaminate adhesive with the applied amount of 120 g/m².

The above drum shells are each produced by unifying three laminate woods such that the fiber-aligning directions on the interior and exterior surfaces are laid in the circumferential direction thereof.

The unified and rolled laminate woods are inserted into the hollow space 41a of the external mold 41 shown in FIG. 6B; then, the internal mold 51 shown in FIG. 7A is inserted into the hollow space 41a so as to sandwich them between the external mold 41 and the internal mold 51.

Subsequently, the heater 55 is attached to the outer periphery of the external mold 41 so as to heat the three laminate woods together with the external mold 41, wherein the compressed air is supplied to the air chamber 54 so as to expand the balloon 53. The pressure of the compressed air for expanding the balloon 53 is maintained at 0.5 MPa, while the external mold 41 and the three laminate woods are heated at a temperature of 100° C. for one hour.

Lastly, the unified laminate woods are extracted from the external mold 41 and the internal mold 51; then, unwanted edges on the upper and lower ends thereof are cut out. Thus, it is possible to produce four types of drum shells according to Examples 1 to 4, each of which is formed in prescribed dimensions, i.e. a diameter of 450 mm, a height of 400 mm, and a thickness of 6 mm. Moreover, drum heads are attached to the drum shells of Examples 1 to 4, thus finishing the respective drums.

### (4) MEASUREMENT

Various types of drum shells are experimentally measured in terms of the relationship between the square root of the specific elastic modulus, i.e. (E/ρ)^{1/2} (km/s) (representing sound-propagating velocity), and the damping factor “tan δ” in the circumference and height directions. Measurement results are shown in Table 1 and FIG. 13. Four samples are prepared with respect to each of Examples 1-4 and each sample is subjected to measurement. FIG. 13 shows the measurement results regarding all samples, while Table 1 shows only the typical values.

TABLE 1

| | Mass per unit | | | |
|---|---|---|---|---|
| | area of Carbon | Damping Factor tan δ | | |
| | Fabric (g/m²) | Circumference | Height | Remarks |
| Example 1 | 30 | 12.06 | 9.04 | Embodiment |
| Example 2 | 60 | 11.54 | 8.98 | Embodiment |
| Example 3 | 90 | Detachment in | | Comparative |
| | | carbon fabric | | |
| Example 4 | 0 | 13.57 | 10.16 | Comparative |

According to Table 1 and FIG. 13, the damping factor tan δ noticeably decreases in Examples 1 and 2 compared to Example 4 (including non-fabric laminate woods). This indicates that the present embodiment is capable of achieving “musically clear and tight” sound quality at the starting durations of drum sounds. Examples 1 and 2 clearly show that as the mass per unit area of the carbon fabric increases, the damping factor tan δ decreases so as to increase sound-propagating velocity, thus markedly improving the sound quality. However, detachment of fibers inside of the carbon fabric occurs in Example 3 with the mass per unit area of 90 g/m² so as to cause breakdown of the drum shell. This indicates that the mass per unit area of the carbon fabric should be less than 90 g/m².

Lastly, the present embodiment and its variations can be further modified within the scope of the invention defined by the appended claims.

What is claimed is:

1. A drum shell including at least one laminate wood in which at least one fiber-reinforced layer is inserted between a first wooden material and a second wooden material via an adhesive.

2. The drum shell according to claim 1, wherein the fiber-reinforced layer is a carbon fabric.

3. The drum shell according to claim 1, wherein a mass per unit area of the fiber-reinforced layer ranges from 5 g/m² to 75 g/m².

4. A drum shell including a plurality of laminate woods which are laminated together via an interlaminate adhesive and each of which is formed by sequentially laminating a first wooden material, a fiber-reinforced layer, and a second wooden material via an adhesive.

5. A drum comprising:
at least one laminate wood which is rolled up into a cylindrical shape; and
at least one drumhead attached to an opening of the cylindrical shape.

6. A manufacturing method of a drum shell comprising:
rolling up at least one laminate wood, which is formed by sequentially laminating a first wooden material, a fiber-reinforced layer, and a second wooden material via an adhesive;
inserting the laminate wood into a hollow space of an external mold;
inserting an internal mold along an interior surface of the laminate wood, so that the laminate wood is tightly sandwiched between the internal mold and the external mold and is formed in a cylindrical shape; and
heating the laminate wood together with the external mold.
